(19) United States
(12) Patent Application Publication
(10) Pub. No.: US 2008/0043146 A1
(43) Pub. Date: Feb. 21, 2008

(54) Display device

(75) Inventor: Chang-Hung Lee, Yuan Lin Hsien (TW)

Correspondence Address: BIRCH STEWART KOLASCH & BIRCH, PO BOX 747, FALLS CHURCH, VA, 22040-0747, US

(73) Assignee: BENQ Corporation

(21) Appl. No.: 11/878,567

(22) Filed: Jul. 25, 2007

(30) Foreign Application Priority Data
Aug. 18, 2006 (TW) 95130553

(51) Int. Cl. H04N 5/50

(52) U.S. Cl. 348/569; 348/E05.097

(57) ABSTRACT

A display device comprises a connecting port, a microprocessor, an on-screen-display circuit and a screen. The display device can connect to a signal source at least. When the microprocessor can not receive the product name of the signal source, the on-screen-display circuit displays the connecting port name on the screen. Otherwise when the microprocessor receives the product name of the signal source, the on-screen-display circuit displays the product name of the signal source on the screen.

### FIELD OF INVENTION

The present invention relates to a display device, and more specifically to the device that can tell and show a product name of a signal source.

### BACKGROUND OF THE INVENTION

Following the advancement of technology in display devices, function enhancement and structure slimness of display apparatus become the mainstream focus. For instance, plane televisions, plasma display apparatuses and liquid crystal display (LCD) devices, etc. all symbolize the trend in slimmer displays. In the display devices, a design of an on-screen-display (OSD) interface makes operation of the display more convenient. The on-screen display is to superimpose an image on a screen picture, commonly used in modern televisions and display devices to display information. When users select viewing options and/or adjust components of the OSD display, such as brightness, contrast, horizontal/vertical positioning, channel, and time, related information can be shown immediately on the screen. Thus, the OSD becomes one of important human-machine interfaces that helps the users to control/adjust the display devices.

Please refer to both FIG. 1A and FIG. 1B, in which FIG. 1A shows a perspective front view of a display device in prior art, and FIG. 1B shows a plane back view of FIG. 1A. User's interfaces on the display device include plural buttons 10, a receiver 12 for receiving signals of the remote control, an LED 14 and speakers 16 on the front housing, and plural output/input connecting ports 18 on the back housing. The plural buttons 10 include a power switch 101, a volume-up button 102, a volume-down button 103, a channel-up button 104, a channel-down button 105, an automatic, button 106, a video selection button 107, and a menu button 108. The plural output/input connecting ports 18 include a digital visual interface (DVI) port 181, a D-Sub VGA port 182, an S-VHS port 183, a video CVBS port 184, a composite port 185 (AV port), a universal serial bus (USB) 186, and so on.

Please refer to FIG. 2, which shows schematically an OSD of the conventional display device. The display device can connect multiple signal sources (electronic apparatus) via the plural output/input connecting ports 18, for instance a digital video disc (DVD) player, a digital video (DV) and a digital video recorder (DVR). The input signal selection of the OSD would show all three video channel selections AV1, AV2 and AV3 with respect to the DVD, DV and DVR. However, when the display device connects these signal sources for example, the users are usually confused with the correct selection around the simple AV1, AV2 and AV3. Generally, the users cannot tell which the AVx (AV1, AV2 or AV3) represents the desired electronic apparatus, and so the user just travels around all these options till the right apparatus is located.

So, the present invention is devoted to improving the OSD circuit on the display device so as to show the product name of each signal source, and thus the display device can help consumers in distinguishing signal sources rapidly and conveniently.

### SUMMARY OF THE INVENTION

The objective of the present invention is to provide a display device which can tell a product name of a signal source connected to the display device and display the product name on the screen.

The display device comprises a connecting port, a microprocessor, a memory, an on-screen-display (OSD) circuit and a screen. The connecting port, the memory and the on-screen-display circuit are all electrically coupled to the microprocessor, individually. When the microprocessor cannot tell the product name of a specific signal source, the OSD circuit would output the connecting port name on the screen. On the other hand, when the microprocessor can read the product name of the signal source, the OSD circuit would show the product name of the signal source directly on the screen.

### BRIEF DESCRIPTION OF THE DRAWINGS

Other features and advantages of this invention will become more apparent in the following detailed description of the preferred embodiments of this invention, with reference to the accompanying drawings, in which:

FIG. 1A shows a perspective front view of a display device in prior art;

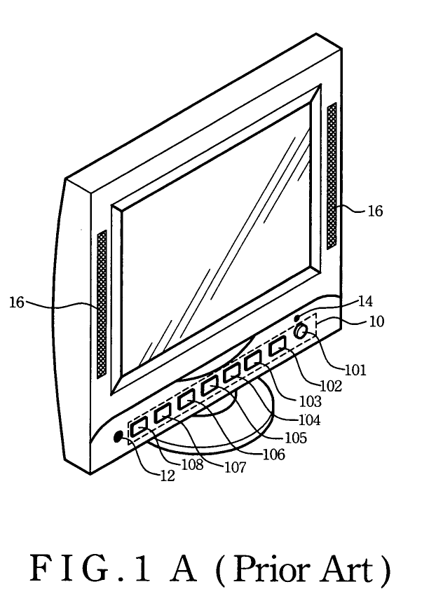

FIG. 1B shows a back view of FIG. 1A;

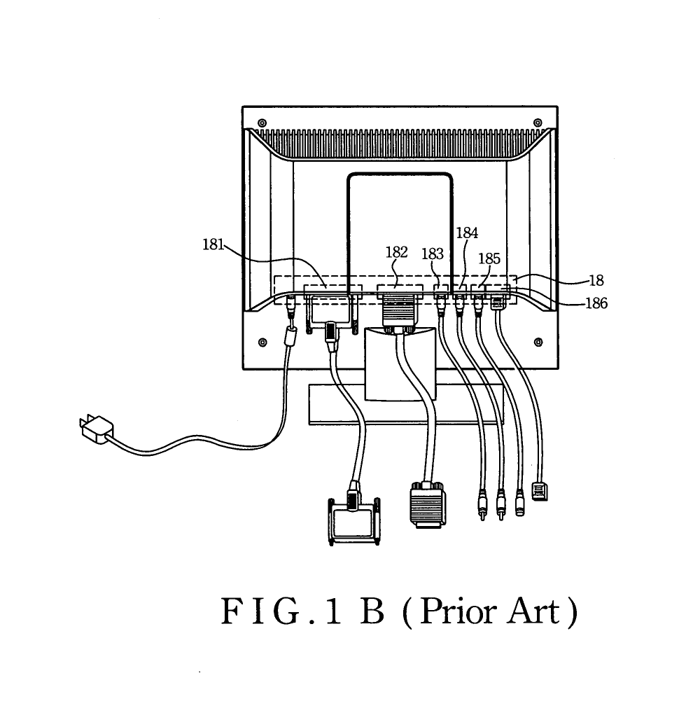

FIG. 2 shows schematically an on-screen display of the conventional display device;

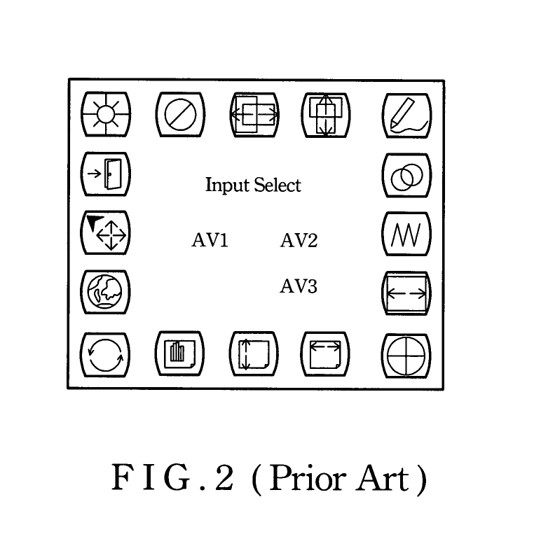

FIG. 3 shows a preferred framework of the display device in accordance with the present invention;

FIG. 4 shows schematically an on-screen display of the display device in accordance with the present invention;

FIG. 5 illustrates a flow chart of distinguishing product names of signal sources in accordance with the present invention; and

FIG. 6 illustrates a typical compound of a product identification code of the signal source in accordance with the present invention.

### DETAILED DESCCRIPTIONS OF THE PREFERRED EMBODIMENT

The present invention is to provide a display device to distinguish product names of signal sources and to display them directly on the screen. It can help users to locate the desired signal source quickly.

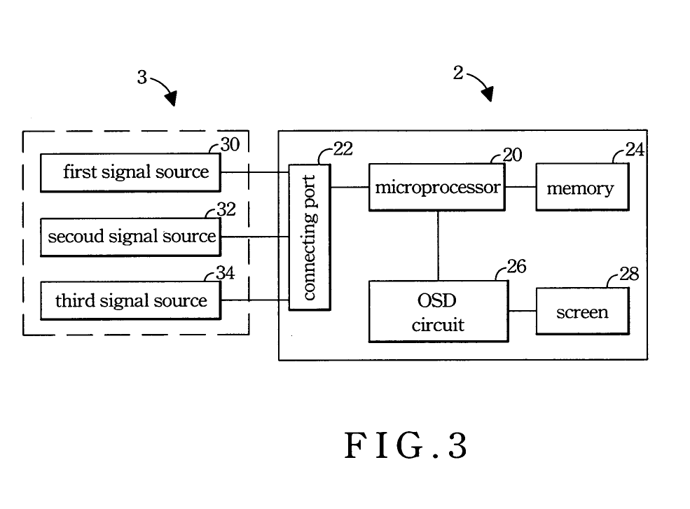

Please refer to FIG. 3, which shows a framework of the display device in accordance with the present invention. The display device 2 comprises a microprocessor 20, a connecting port 22, a memory 24, an on-screen-display (OSD) circuit 26 and a screen 28. The connecting port 22 is connected to a plurality of signal sources 3, including a first signal source 30, a second signal source 32, and a third signal source 34. The plural signal sources 3 can be digital or analog sources that can transmit signals to the microprocessor 20. The microprocessor 20 receives signals and outputs the signals having product names to the OSD circuit 26. The OSD circuit 26 sends the product names of the respective signal sources to the screen 28 for user's easy option upon the various signal sources.

The microprocessor 20 can store the product names of the signal sources in the memory 24 temporarily, and so the display device 2 needs to read the name information of the signal sources 30, 32 and 34 at the first time only. The process of storing the product names of the signal sources in the memory 24 temporarily can avoid the display device 2 to repeat the complicate communication procedure with these three signal sources 30, 32, and 34 while the users reactivate the OSD function during the operation.

The memory 24 can also store some specific product identification codes including product brands, product names, information of products, and product codes accompanying with the products. The microprocessor 20 receives the product identification codes of the signal sources and compares with the data in the memory 24 to tell the signal sources currently connected with the display device 2. Then, the on-screen display can display the product brands, the product names, and other information of the signal sources more detailed. The display device 2 can only read simple codes of the three signal sources 30, 32 and 34, and then the on-screen display can follow to show detail information of each signal source (pre-stored in the memory 24) so as to reduce the data transmission flow in between effectively.

The display device 2 can also allow users to replace the product information stored in the memory 24 by a remote control (also called user input interface) or buttons on the display devices 2. If the display device 2 is unable to tell any product identification code of the three signal sources 30, 32 and 34, or if any of the three signal sources 30, 32 and 34 does not provide its product identification code, the users can enter the product information artificially to show on the on-screen display.

In the above embodiment, the memory 24 can be optional to the display device 2. The display device 2 can also waive the memory, and makes the microprocessor 20 to transmit the received video signals with product identification code to the on-screen display and to directly show the accompanying product identification code on the screen.

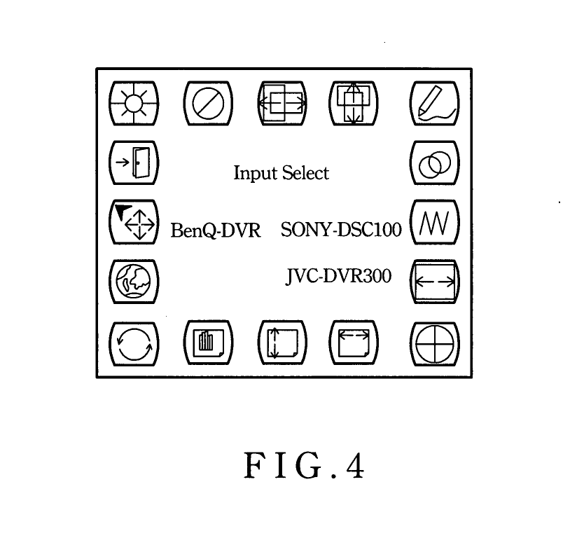

Please refer to FIG. 4, in which a schematic on-screen display of the display device in accordance with the present invention is shown. The display device can show plural video channels and data of the plural video channels supported by the plural signal sources connected with the display device. All the feasible video channels of the display device are superimposed on the screen. The product names are shown on the on-screen display for the user to choose freely. As shown in FIG. 4, the three signal sources are respectively a BenQ-DVR (the first signal source), a SONY-DSC100 (the second signal source) and a JVC-DVR300 (the third signal source).

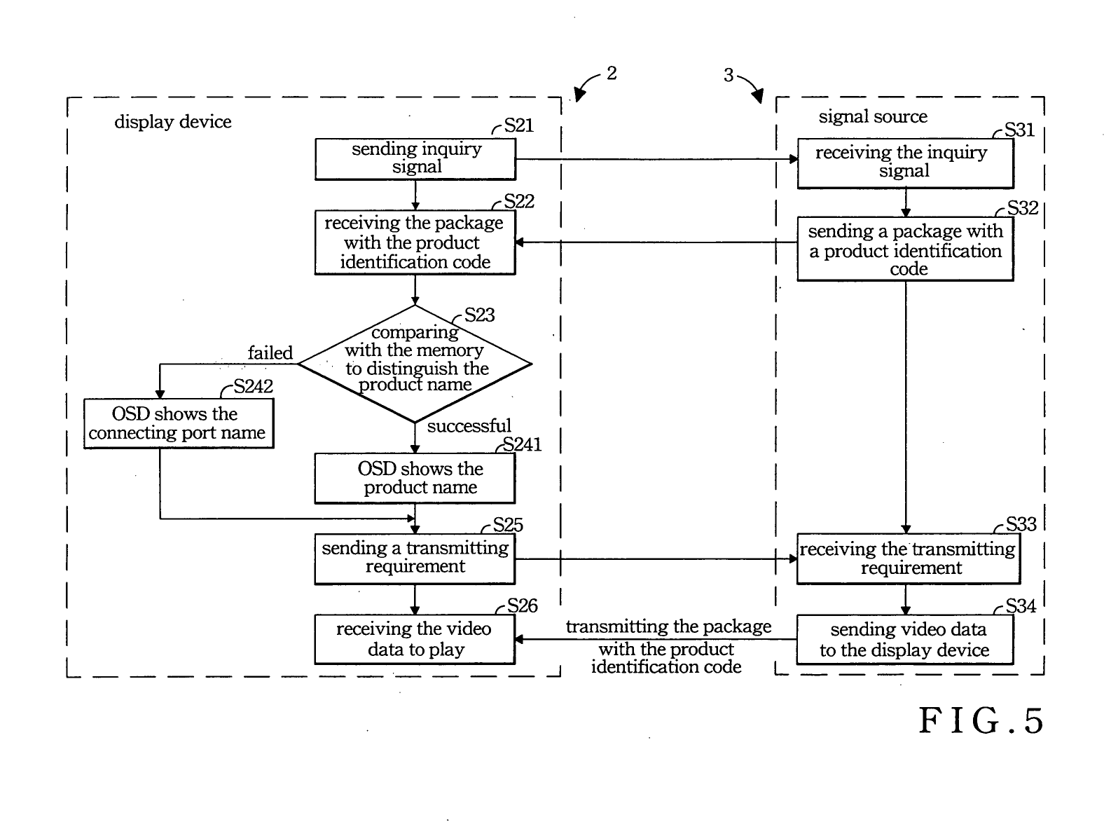

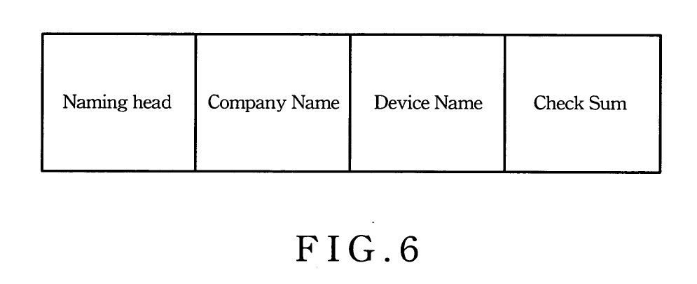

Please refer to FIG. 5 and FIG. 6 at the same time, in which FIG. 5 illustrates a flow chart of distinguishing product names of signal sources in accordance with the present invention, and FIG. 6 illustrates a typical compound of a product identification code of the signal source in accordance with the present invention. In FIG. 5, video signal flows of receiving signals, distinguishing product names and displaying product names on the screen between the display device 2 and the signal source 3 are illustrated.

First of all, In step S21, with the signal source 3 connected to the display device 2 via the connecting port, the display device 2 sends an inquiry signal to the signal source 3. In Step S31, the signal source 3 receives the inquiry signal. In Step S32, the signal source 3 sends a package with a product identification code, in which the product identification code includes code information of company name, model number, device name, and so on as shown in FIG. 6. In Step S22, the display device 2 receives the package with the product identification code. In Step S23, the microprocessor compares the product identification code with the data of the memory and discerns the brand (of electronic apparatus) of the current signal source. In the present invention, the data pre-stored in the memory may be the complete product identification code, part of the product identification code, product code or the company name.

If the microprocessor finds any product code established in the memory coherent with the receiving product identification code in a predetermined way, then, in the following step S241, the product name (BENQ-DVR for example) corresponding to the identified product identification code would be shown on the on-screen display. Otherwise, if the receiving product identification code cannot meet any product code established in the memory, then, in the following step S242, the display device 2 would show the connecting port name (AV1 or EXT1 for example) on the on-screen display.

In the present invention, the microprocessor stores only temporally the product name of the signal source or the connecting port name in the memory. After the step 23, the signal source 3 and the display device 2 would enter an auto-connecting process to wait for the auto-connecting process to be finished. If the user wants to see the data of the signal source 3, the user can send a playing command to both the display device 2 and the signal source 3. Then, in the following step S25, the display device 2 would send a transmitting requirement for demanding the signal source 3 to forward video data (signal) to the display device 2. In Step S33, the signal source 3 receives the transmitting requirement. In Step S34, the signal source 3 transmits the video data (signal) to the display device 2. In Step S26, the display device 2 receives and processes the video data (signal) to further show on the screen.

As shown in FIG. 6, the package with the product identification code can include the product code having a naming head of the package, the company name or the model number, the device name, and a check sum. Preferably, the memory of the display device can pre-store a great amount of product codes and product identification codes of most the electronic apparatuses already existed in the marketplace. Then, the display device can identify successfully the product name of the signal source from the established product codes.

In the above mentioned process, the product identification code of the signal source is transmitted to the display device for a distinguishing purpose while the signal source is initially connected to the display device. Also, the product identification code can be repeatedly transmitted to the display device in a predetermined interval during the video data (signal) transmission.

By providing the aforesaid identification process upon the incoming signal sources and further to demonstrate the information of the incoming signal sources on the screen of the display device in accordance with the present invention, the user can choose conveniently his/her favorite signal source rapidly.

Although the present invention and its advantages have been described in detail, as well as some variations over the disclosed embodiments, it should be understood that various other changes, substitutions and alterations can be made herein without departing from the spirit and scope of the invention as defined by the appended claims.

What is claimed is:

1. A display device, connecting a signal source, comprising:
a connecting port, coupled to the signal source, assigned with a connecting port name;
a microprocessor, coupled to said connecting port, obtaining a product name from the signal source through said connecting port;
an on-screen-display (OSD) circuit electrically coupled to said microprocessor; and
a screen electrically coupled to said OSD circuit;
wherein when said microprocessor does not receive the product name of the signal source, said OSD circuit displays the connecting port name on said screen; and
wherein when said microprocessor receives the product name of the signal source, said OSD circuit displays the product name of the signal source on said screen.

2. The display device according to claim 1, wherein said microprocessor outputs an inquiry signal to the signal source and then receives a package from the signal source to obtain the product name of the signal source.

3. The display device according to claim 1, wherein said microprocessor obtains the product name of the signal source from a video signal transmitted from the signal source.

4. The display device according to claim 1, wherein said microprocessor obtains the product name by exchanging signals between the signal source and the connecting port when the microprocessor confirms the signal source connected with said connecting port.

5. The display device according to claim 1, further comprising a memory coupled to said microprocessor for storing the connecting port name.

6. The display device according to claim 5, wherein said microprocessor further stores the product name of the signal source in said memory.

7. The display device according to claim 5, further comprising a user input interface used to input characters; wherein, when the microprocessor obtains a user defined name inputted by a user via the user input interface, the user defined name is used to replace the product name stored in the memory.

8. The display device according to claim 6, wherein when the user enabling the OSD circuit, the microprocessor reads the product name of the signal source stored in said memory and the OSD circuit displays the product name on the screen.

9. A method for enabling a display device display a product name of a signal source, the display device comprises a connecting port, a microprocessor, an on-screen-display (OSD) circuit and a screen, the connecting port and the OSD circuit coupled to the microprocessor, the method comprising the following steps of:
(1) the signal source transmitting the product name to the display device;
(2) the display device receiving the product name;
(3) the microprocessor transmitting the product name to the OSD circuit; and
(4) the OSD circuit displaying the product name of the signal source on the screen.

10. A method for enabling a display device display a product name of a signal source, the display device comprising a connecting port, a microprocessor, a memory, an on-screen-display (OSD) circuit and a screen; the connecting port, the memory and the OSD coupled to the microprocessor respectively; the screen coupled to the microprocessor via the OSD circuit; the method comprising the steps of:
(1) the signal source transmitting a product identification code of the signal source to the display device;
(2) the display device receiving the product identification code of the signal source;
(3) the microprocessor determining whether the memory storing a product name corresponding to the product identification code;
(4) when the product name corresponding to the product identification code stored in the memory, the product name transmitted to the OSD circuit and the OSD circuit displaying the product name on the screen; and
(5) when the product name corresponding to the product identification code absence from the memory, the connecting port name transmitted to the OSD circuit and the OSD circuit displaying the connecting port name on the screen.

11. The method according to claim 10, wherein in the step (4) the microprocessor compares the product identification code with data of the memory and stores the product name with a matching code into the memory.

12. The method according to claim 11, wherein the display device further comprises a user input interface, and wherein in the step (4) the microprocessor obtains a user defined name inputted by a user via the user input interface to replace the product name stored in the memory.

13. The method according to claim 10, further comprising a step before the step (1): the display device sending an inquiry signal to the signal source.

14. A display device connecting a signal source, comprising:
a connecting port, coupled to the signal source, assigned a connecting port name;
a user input interface for a user to input a user defined name corresponding to the connecting port;
a memory for storing the connecting port name and the user defined name;
a microprocessor electrically coupled to the memory, the connecting port and the user input interface;
an on-screen-display (OSD) circuit electrically coupled to said microprocessor; and
a screen electrically coupled to said OSD circuit;
wherein when the microprocessor determines the user defined name stored in the memory, the OSD circuit displays the user defined name on said screen,
wherein when the microprocessor determines no user defined name stored in the memory, the OSD circuit displays the connecting port name on said screen.

15. The display device according to claim 14, wherein said microprocessor outputs an inquiry signal to the signal source and then receives a package from the signal source to obtain the product name of the signal source.

16. The display device according to claim 14, wherein said microprocessor obtains the product name of the signal source from a video signal transmitted from the signal source.

17. The display device according to claim 14, wherein said microprocessor obtains the product name by exchanging signals between the signal source and the connecting port when the microprocessor confirms the signal source connected with said connecting port.

18. The display device according to claim 14, wherein said microprocessor further stores the product name of the signal source in said memory.

19. The display device according to claim 18, wherein when the microprocessor obtains the user defined name inputted by a user, the user defined name is used to replace the product name stored in the memory.

20. The display device according to claim 14, wherein when the user enabling the OSD circuit, the microprocessor reads the product name of the signal source stored in said memory and the OSD circuit displays the product name on the screen
